(19) United States
(12) Patent Application Publication
(10) Pub. No.: US 2006/0017968 A1
(43) Pub. Date: Jan. 26, 2006

(54) Digital image providing system

(75) Inventor: Yoshinori Usami, Tokyo (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/184,853

(22) Filed: Jul. 20, 2005

(30) Foreign Application Priority Data
Jul. 21, 2004 (JP) 2004-213486

(51) Int. Cl. G06F 15/00

(52) U.S. Cl. 358/1.15

(57) ABSTRACT

The present invention provides a digital image providing system comprising a processing information obtaining device which obtains processing information for performing required image processing on an original image of a customer taken at a photo-studio, an encrypting device which encrypts the obtained processing information, a decrypting device which decrypts the encrypted processing information, and a device which records the original image of the customer and the encrypted processing information of the original image in association with each other on a recording medium to be provided for the customer or uploads them to a server accessible to the customer.

### BACKGROUND OF THE INVENTION

1. Field of the Invention

The present invention relates to a digital image providing system, and more specifically to a technique for providing a customer a digital image taken at a photo studio or a studio rent for photo-taking.

2. Related Art

FIG. 7 is a diagram for illustrating a conventional work flow at a photo studio from registering a customer to outputting a photo print.

As shown in FIG. 7, a customer is registered at the reception of a photo studio (step S10) and taken a digital photograph with a digital camera, from which or from whose recording medium, the taken image is captured into an image database (step S12). Then, the image taken by the digital camera is displayed on a display device at the photo studio and presented to the customer to let him select an image to be printed (step S14).

An image processing device at the photo studio keeps the digital image selected at the presentation, and performs image processing including color correction, trimming and layout combine (embedding of an image in a template) on the selected digital image with image processing software (step S16). Then, the image-processed digital image is outputted to a printer 1 at the photo-studio. The photo print created by the printer 1 is provided to the customer.

A system is proposed for enabling images taken by professional photographers to be viewed and ordered for printing on a network and the photo-prints thereof to be bought on a network (Japanese Patent Application Laid-open No. 2002-49798).

In the case of conventional photography with a film camera, for example, on a negative film at a photo-studio, the negative film taken is kept at the photo-studio as a “copyrighted material” to prevent the customer from taking the negative film to another photo-studio or photo-finishing store to have the picture printed. Some photographers sell customers the taken negative films with the copyright on the taken pictures.

On the other hand, in the case of photography with a digital camera as shown in FIG. 7, an image can be viewed immediately after the shooting. This is advantageous in inviting a customer to buy prints and also in stimulating a customer's desire for obtaining digital images taken at a photo-studio and processing the images for his pleasure.

As disclosed in Japanese Patent Application Laid-open No. 2002-109248, an image editing system for providing edition samples of an image or a menu for a customer to select and order the image for printing and charging the customer for the prints is also proposed.

### SUMMARY OF THE INVENTION

In the case of the image editing system described in Japanese Patent Application Laid-open No. 2002-109248, a customer is serviced image processing and printing by passive or semi-passive selection form the choices, though the customer cannot repeatedly obtain a quite original finished print, which was once taken at a photo-studio.

On the other hand, if a photo-studio easily gives an image-processed digital image or processing information performed on an original image to a customer, an image processing technique, which is a “copyrighted material” on the photo-studio, is also considered to be transferred to the customer. Thus, the photo-studio is unable to protect its right and loses its business opportunity in its secondary service of printing the image.

The present invention is adapted in the view of the circumstances above and intends to provide a digital image providing system that protects image data, to which the customer has a right (a right of portrait), and a processing technique and processing information on the image, to which the professional photographer has a right (a copyright), while keeping a benefit of repeatedly serving photo-prints with a quality satisfactory to a customer and protecting business opportunity of the professional photographer.

In order to achieve the abovementioned object, a digital image providing system according to the first aspect of the present invention includes a processing information obtaining device which obtains processing information for performing required image processing on an original image of a customer taken at a photo-studio; an encrypting device which encrypts the obtained processing information; a decrypting device which decrypts the encrypted processing information; and a device which records the original image of the customer and the encrypted processing information of the original image in association with each other on a recording medium to be provided for the customer or uploads them to a server accessible to the customer.

Although image processing including color correction, trimming and layout combine (picture creation) on the assumption of printing is performed on an original image of a customer taken with a digital camera at a photo-studio or obtained by digitizing a film, the original image and the processing information for picture creation are obtained separately and the obtained processing information is encrypted. The original image of the customer and the encrypted processing information on the original image are associated with each other, recorded on a recording medium and provided for the customer or uploaded to a server accessible to the customer so that the customer can view or download them.

In other words, the customer can obtain his original image but not the processing information that indicates image-processing performed on the original image at the photo-studio, as the information is encrypted. This protects a right (a copyright) of the photo-studio.

The second aspect of the present invention is the digital image providing system according to the first aspect, further including a database which manages a decryption key for decrypting the encrypted processing information in association with customer information for identifying a customer, wherein the encrypting device encrypts the obtained processing information with an encryption key different for each customer, and the decrypting device retrieves a corresponding decryption key based on the customer information from the database and decrypts the encrypted processing information. With encryption/decryption different for each customer, the processing information can be protected more tightly.

The third aspect of the present invention is the digital image providing system according to the first aspect, further including an image processing device which processes the original image of the customer based on the processing information decrypted by the decrypting device and an outputting device which outputs the original image subjected to the image-processing.

In other words, as the photo-studio has a decryption key for decrypting encrypted processing information and can obtain processing information by using the decryption key, the photo-studio can create another photo print in reprinting an image with the same finish as that of the first photo-print.

A digital image providing system according to the fourth aspect of the present invention includes a processing information obtaining device which obtains processing information for performing required image processing on an original image of a customer taken at a photo-studio; a first database which stores the obtained processing information in a predetermined storage in association with the original image of the customer; an encrypting device which encrypts information indicating the storage of the processing information; a decrypting device which decrypts the encrypted information indicating the storage; and a device which records the original image of the customer and the encrypted information indicating the storage of the processing information of the original image in association with each other on a recording medium to be provided for the customer or uploads them to a server accessible to the customer.

In other words, the first aspect is adapted to encrypt processing information, while the fourth aspect is adapted to encrypt information indicating storage where the processing information is stored.

The fifth aspect of the present invention is the digital image providing system according to the fourth aspect, further including a second database which manages a decryption key for decrypting the encrypted information indicating the storage in association with customer information for identifying a customer, wherein the encrypting device encrypts the information indicating the storage of the processing information with an encryption key different for each customer, and the decrypting device retrieves a corresponding decryption key based on the customer information from the second database and decrypts the encrypted information indicating the storage.

The sixth aspect of the present invention is the digital image providing system according to the fourth aspect, further including a device which retrieves the processing information from the first database based on information indicating the storage decrypted by the decrypting device; an image processing device which processes the original image of the customer based on the retrieved processing information; and an outputting device which outputs the original image subjected to image-processing.

The seventh aspect of the present invention is the digital image providing system according to the first or fourth aspect, wherein the image processing performed on the original image includes at least one of color correction, trimming and layout combine on the original image.

The eighth aspect of the present invention is the digital image providing system according to the first or fourth aspect, wherein the encrypted information is embedded in the original image as a digital watermark.

The ninth aspect of the present invention is the digital image providing system according to the first or fourth aspect, wherein the encrypted information is stored on the header of the image file where the original image is stored.

The present invention is adapted to separate an original image and processing information on picture creation, encrypt the processing information or the information on the storage of the processing information, provide the original image of a customer and the encrypted information on a recording medium to be provided to the customer or upload them to a server accessible to the customer so that the customer can obtain his original image (digital image) and a professional photographer can protect processing information on the image, to which the professional photographer has a right (a copyright). A professional photographer who has a decryption key for decrypting the encrypted information can retrieve processing information as required and provide the customer another photo print with the same finish as the first photo print.

### BRIEF DESCRIPTION OF THE DRAWINGS

FIG. 1 is a block diagram illustrating an embodiment of a digital image providing system according to the present invention;

FIG. 2 is a block diagram showing an essential part of a system shown in FIG. 1 that functions in reprinting;

FIG. 3 is a block diagram showing an essential part for illustrating a problem in reprinting the image at another photo-studio;

FIG. 4 is a block diagram illustrating another embodiment of a digital image providing system according to the present invention;

FIG. 5 is a block diagram showing an essential part of a system shown in FIG. 4 that functions in reprinting;

FIG. 6 is a block diagram showing an essential part for illustrating a problem in reprinting the image at another photo-studio; and

FIG. 7 is a diagram for illustrating a conventional work flow at a photo studio from registering a customer to outputting a photo print.

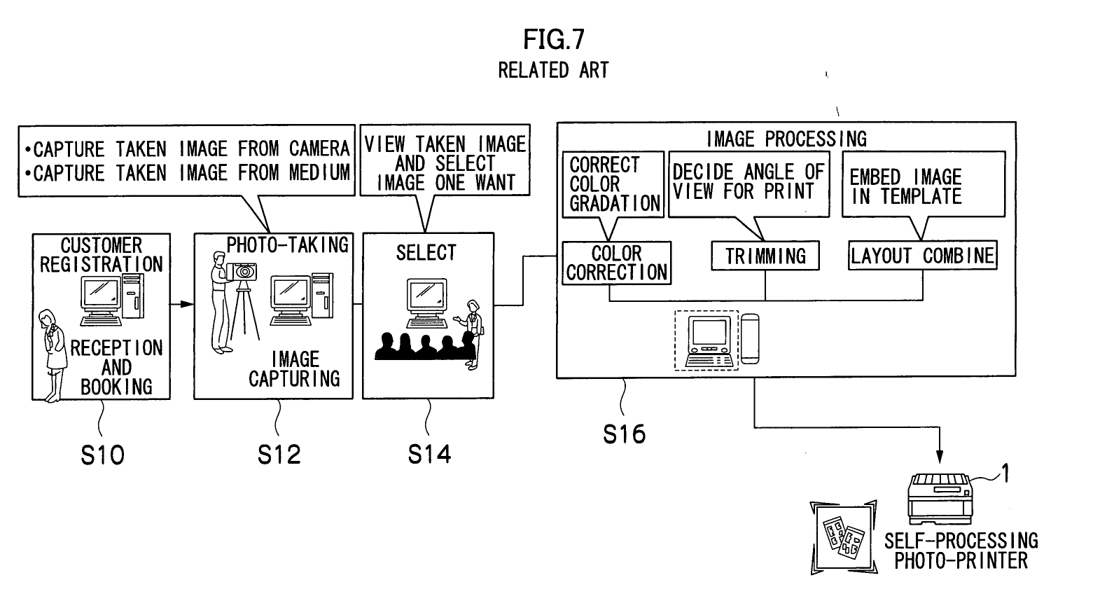

### DETAILED DESCRIPTION OF THE PREFERRED EMBODIMENTS

Now, preferred embodiments of the digital image providing system according to the present invention will be described in detail with reference to accompanying drawings.

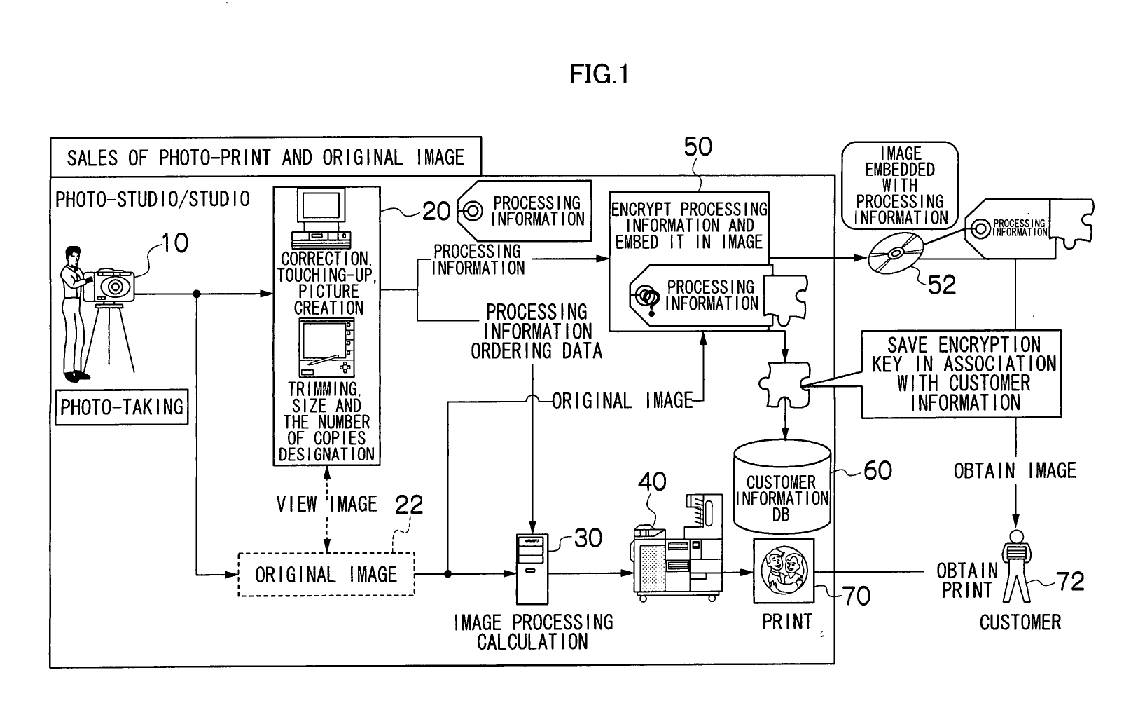

FIG. 1 is a block diagram illustrating an embodiment of a digital image providing system according to the present invention where the system is provided at a photo-studio/a studio.

This system mainly includes a digital camera 10, image processing devices 20, 30, a photo-printer 40, an encrypting/decrypting device 50 and a customer information database 60.

The digital camera 10 sends out original image data to the image processing device 20 over interface such as IEEE 1394 each time it takes digital picture of a customer at a studio.

The image processing device 20 includes a personal computer (PC) with software corresponding to various types of image-processing and processing of printing order or the like. The image processing device 20 stores image data of an original image captured from the digital camera 10 in its built-in or external storage 22.

The image data of the original image is unprocessed RAW data outputted from an image pickup device such as a CCD or a CMOS in the digital camera 10 or image data which is developed at the digital camera 10 and to be subjected to image-processing by the image processing device 20. If the image is taken by film camera, the image data of the original image is image data which is read by scanner as a negative image and digitized.

An operator inputs processing information for performing image processing (picture creation) including color correction, grey level correction, trimming and layout combine (template combine) on the original image, which a customer orders to print, in the image processing device 20 as required. The processing information inputted for the original image is saved at a temporally storing device in association with the original image. When the customer orders to print the image, details of printing order indicating a print size and the number of copies are confirmed and indication is inputted at the image processing device 20. The ordering data indicating the details of the printing order is saved at the temporally storing device in association with the original image as the processing information is stored.

The image processing information 20 has a function of creating a view image indicating a processing outcome according to the processing information inputted for the original image and displaying the view image on a display device as sub-function for inputting various types of processing information.

When an indication to print an image is inputted from the image processing device 20, the original image which is indicated to be printed and processing information and ordering data on the original image are outputted to the image processing device 30.

The image processing device 30 creates an image for printing by performing image processing on the original image based on the original image to input and the processing information and the ordering data on the original image, and sends the processed image for printing and the ordering data including a print size and the number of copies to the photo-printer 40. Here, the image processing device 20 and image processing device 30 can be the same.

The photo-printer 40 prints an image by scanning and exposing the image on a sheet of silver halide color paper with R, G and B lasers based on the processed image for printing inputted from the image processing device 30.

The photo-print 70 that is created in the abovementioned manner is provided for a customer 72.

Next, an example of providing a digital image for a customer will be described.

The encrypting/decrypting device 50 is for encrypting processing information with an encryption key or decrypting the encrypted processing information with a decryption key. The encrypting/decrypting device 50 embeds the encrypted processing information in the original image and records it together with the original image on a recording medium 52 such as a CD-ROM to be provided for the customer. The decryption key for decrypting the encrypted processing information embedded in the original image is managed for each customer by the customer information database 60 that manages customer information such as street address, name, telephone number and the like.

Either a private key scheme or a public key scheme may be adopted as an encryption scheme. That is to say, the same key can be used as an encryption key and a decryption key and the key is kept in secret (private key scheme) or an encryption key is released with a decryption key still kept in secret (public key scheme).

A photo-studio provides (sells) the customer 72 the photo-print 70 together with the recording medium 52 that stores the original image. This enables the customer 72 to freely use the original image (digital image) recorded on the recording medium 52.

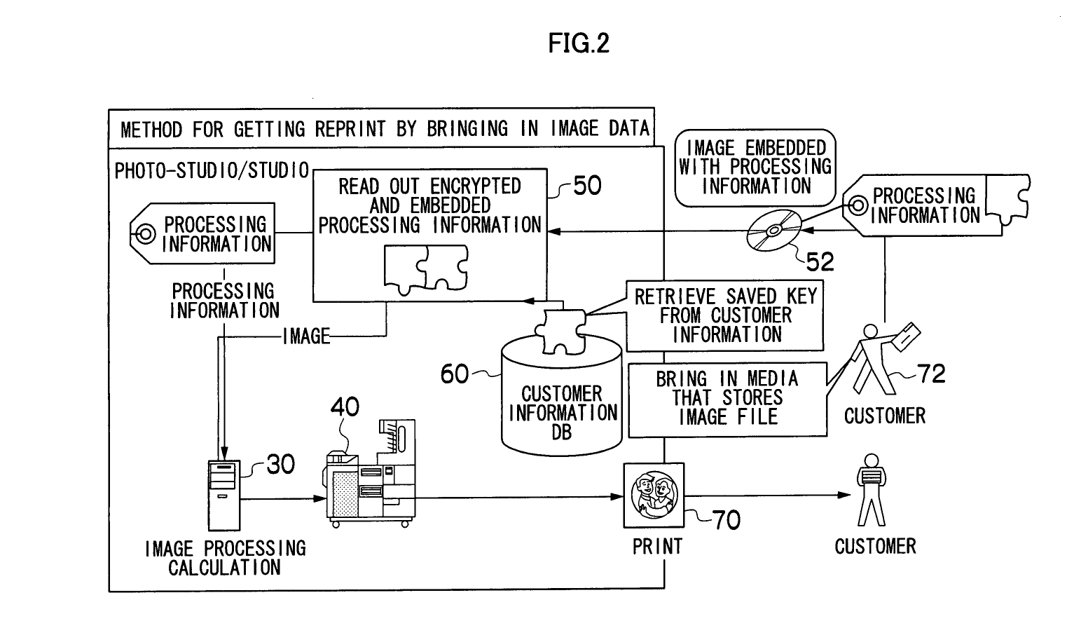

Next, an example of reprinting an image will be described with reference to FIG. 2. The same parts in FIG. 2 and in FIG. 1 are designated with the same reference numerals.

As shown in FIG. 2, the customer 72 brings the recording medium 52 that stores the original image to the photo-studio where the recording medium 52 is created and orders to reprint the image.

The encrypting/decrypting device 50 that accepted the reprinting order retrieves the decryption key associated with the customer information from the customer information database 60, extracts encrypted processing information embedded in the original image on the recording medium 52, and decrypts the encrypted processing information with the retrieved decryption key. Then, the encrypting/decrypting device 50 outputs the decrypted processing information along with image data of the original image read out from the recording medium 52 to the image processing device 30.

Subsequently, a photo-print 70 is created via the image processing device 30 and the photo-printer 40 in the same manner as that described in printing with reference to FIG. 1 and provided to the customer 72. In this case, as the same processing information as used at the previous printing is used, the reprinted photo-print 70 has the same finish as that of the previous one.

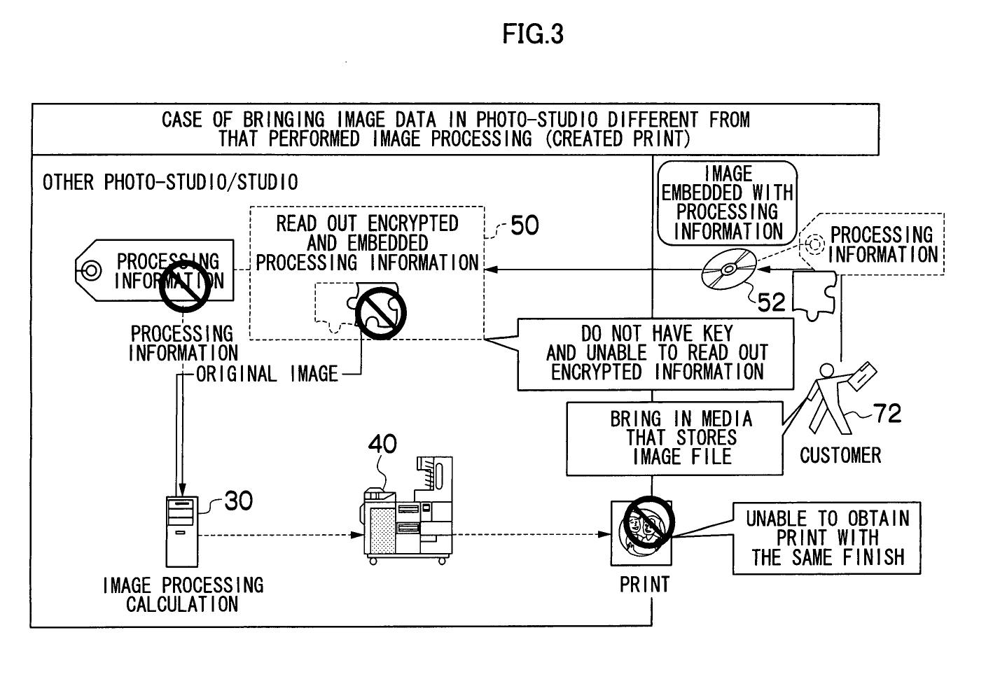

FIG. 3 illustrates an example that the customer 72 brings the recording medium 52 to a photo-studio different from that created the recording medium 52.

As the photo-studio different from that created the recording medium 52 has neither the encrypting/decrypting device 50 nor a decryption key associated with customer information on the customer 72, it cannot extract processing information from the recording medium 52 and decrypt the information.

Therefore, the image processing device 30 creates an image for printing based on image data of the original image read out from the recording medium 52, or image data of the original image and processing information on picture creation performed anew at the photo-studio and sends the image for printing to the photo-printer 40, which in turn creates a photo-print based on the image for printing inputted from the image processing device 30. In this case, as the original image has not been subjected to image processing or has been subjected to image processing according to different information, the customer 72 cannot obtain a photo-print with the same finish as that of the previous one.

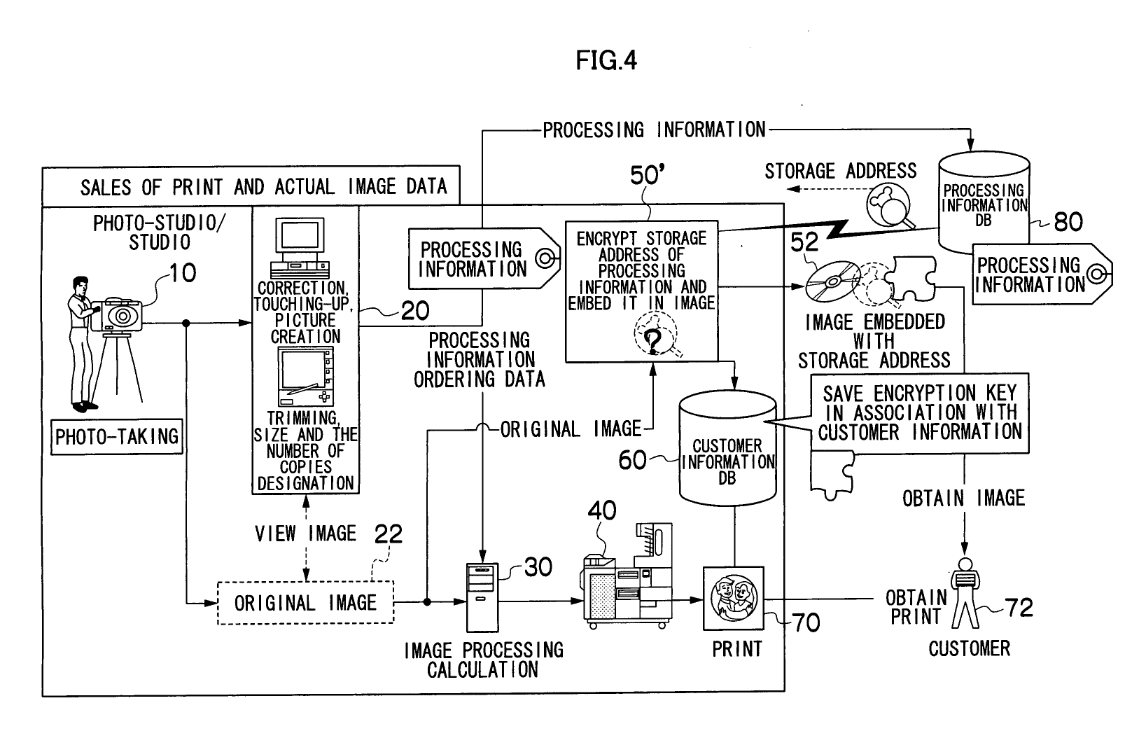

FIG. 4 is a block diagram illustrating another embodiment of a digital image providing system according to the present invention where the system is provided at a photo-studio/a studio. The same parts in FIG. 4 as those in the system shown in FIG. 1 are designated with the same reference numerals and the description in detail thereof will be omitted.

Different from the system shown in FIG. 1, the system shown in FIG. 4 has a encrypting/decrypting device 50′ whose function is different from that of the system shown in FIG. 1 and has processing information database 80 in addition.

In FIG. 4, processing information inputted for an original image according to picture creation by the image processing device 20 is stored in the processing information database 80 on a network in association with the original image.

The encrypting/decrypting device 50′ is for encrypting storage address of processing information stored in the processing information database 80 or decrypting the encrypted storage address with a decryption key. The encrypting/decrypting device 50′ embeds the encrypted storage address in the original image and records the encrypted storage address together with the original image on a recording medium 52 to be provided for the customer such as a CD-ROM. The decryption key for decrypting an encrypted storage address embedded in the original image is managed by the customer information database 60 for each customer.

The photo-studio provides (sells) the customer 72 a photo-print 70 created by the photo-printer 40 together with the recording medium 52 that stores the original image. This enables the customer 72 to freely use the original image (digital image) recorded on the recording medium 52.

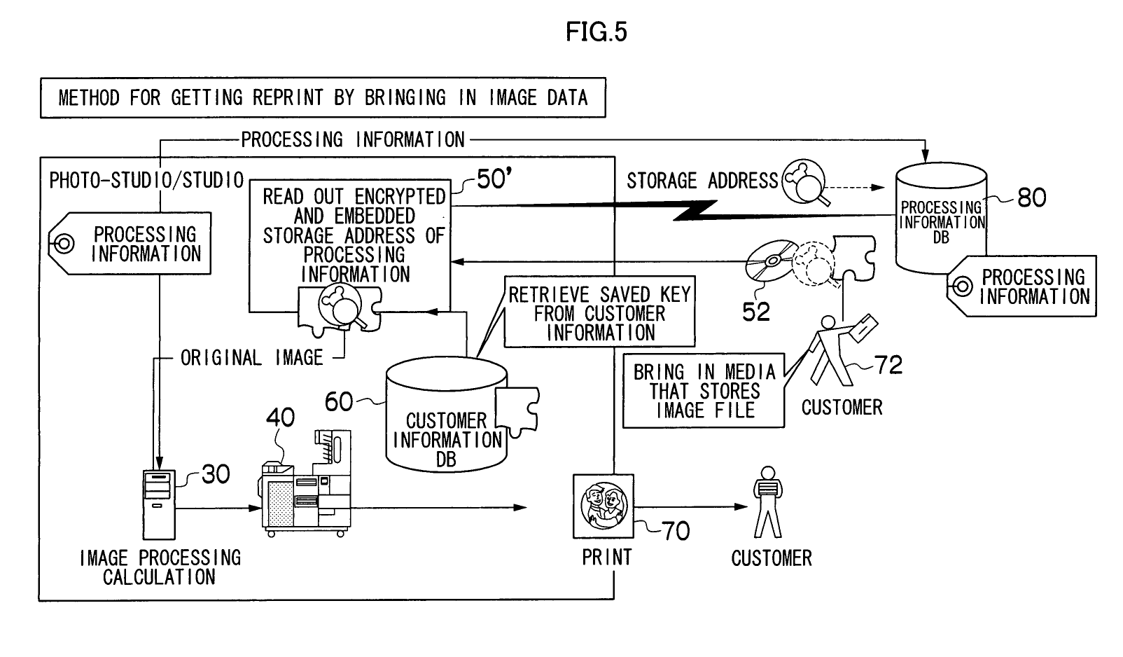

Next, an example of reprinting an image will be described with reference to FIG. 5. The same parts in FIG. 4 and FIG. 1 are designated with the same reference numerals.

As shown in FIG. 5, the customer 72 brings the recording medium 52 that stores the original image to the photo-studio where the recording medium 52 is created and orders to reprint the image.

The encrypting/decrypting device 50′ that accepted the reprinting order retrieves the decryption key associated with the customer information from the customer information database 60, extracts encrypted storage address embedded in the original image on the recording medium 52, and decrypts the encrypted storage address with the retrieved decryption key.

The encrypting/decrypting device 50′ captures the processing information stored at the storage address from the processing information database 80 on a network based on the decrypted storage address and outputs the processing information to the image processing device 30, and also outputs the image data of the original image read out from the recording medium 52 to the image processing device 30.

Subsequently, a photo-print 70 is created via the image processing device 30 and the photo-printer 40 in the same manner as that described in printing with reference to FIG. 4 and provided to the customer 72. In this case, as the same processing information as used at the previous printing is used, the reprinted photo-print 70 has the same finish as that of the previous one.

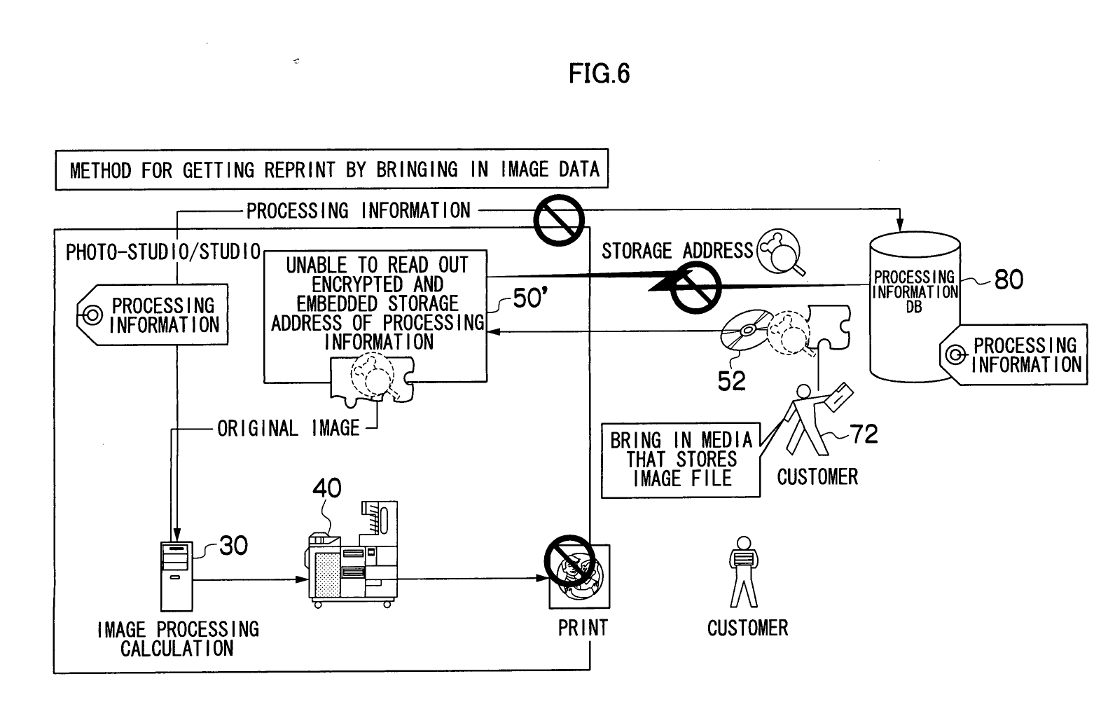

FIG. 6 illustrates an example that the customer 72 brings the recording medium 52 to a photo-studio different from that created the recording medium 52.

As the photo-studio different from that created the recording medium 52 has neither the encrypting/decrypting device 50′ nor a decryption key associated with customer information on the customer 72, it cannot extract storage address from the recording medium 52 and decrypt the information nor capture the processing information corresponding to the original image from the processing information database 80 on a network.

Therefore, the image processing device 30 creates an image for printing based on image data of the original image read out from the recording medium 52 or image data on the original image and processing information on picture creation performed anew at 30 the photo-studio and sends the image for printing to the photo-printer 40, which in turn creates a photo-print based on the image for printing inputted from the image processing device 30. In this case, as the original image has not been subjected to image processing or has been subjected to image processing according to different information, the customer 72 cannot obtain a photo-print with the same finish as that of the previous one.

Although this embodiment is described to manage a decryption key different for each customer, the present invention is not limited to this example and each photo-studio may have one decryption key (private key) and commonly use the decryption key for the decryption of encrypted information.

Although this embodiment is described that encrypted processing information or storage address is embedded in an original image in the form of a digital watermark, the present invention is not limited to this example and they may be recorded on the header of an image file that stores each original image.

Moreover, although the original image (digital image) is described to be provided to a customer on a recording medium, the present invention is not limited to this example and the original image and the like may be uploaded to a network server and the customer may be informed of the password and customer ID to view or download his original image.

Further, although the processing information database 80 shown in FIG. 4 is provided on a network, the database 80 can be processing information database dedicated to a photo-studio and provided at the photo-studio.

Multiple types of processing information indicating various types of image processing to be performed on an original image or a storage address where multiple types of processing information is stored may be encrypted with different encryption keys respectively, and multiple decryption keys for decrypting the various types of encrypted information respectively may be managed in database in association with customer information or the original image of the customer. This enables copyright on image processing to be divided (for example, copyright only on color correction, only on color correction and sharpness processing, or only on trimming).

What is claimed is:

1. A digital image providing system comprising:
a processing information obtaining device which obtains processing information for performing required image processing on an original image of a customer taken at a photo-studio;
an encrypting device which encrypts the obtained processing information;
a decrypting device which decrypts the encrypted processing information; and
a device which records the original image of the customer and the encrypted processing information of the original image in association with each other on a recording medium to be provided for the customer or uploads them to a server accessible to the customer.

2. The digital image providing system according to claim 1, further comprising a database which manages a decryption key for decrypting the encrypted processing information in association with customer information for identifying a customer;
wherein the encrypting device encrypts the obtained processing information with an encryption key different for each customer, and the decrypting device retrieves a corresponding decryption key based on the customer information from the database and decrypts the encrypted processing information.

3. The digital image providing system according to claim 1, further comprising:
an image processing device which processes the original image of the customer based on the processing information decrypted by the decrypting device; and
an outputting device which outputs the original image subjected to the image processing.

4. A digital image providing system, comprising:
a processing information obtaining device which obtains processing information for performing required image processing on an original image of a customer taken at a photo-studio;
a first database which stores the obtained processing information in a predetermined storage in association with the original image of the customer;
an encrypting device which encrypts information indicating the storage of the processing information;
a decrypting device which decrypts the encrypted information indicating the storage; and
a device which records the original image of the customer and the encrypted information indicating the storage of the processing information of the original image in association with each other on a recording medium to be provided for the customer or uploads them to a server accessible to the customer.

5. The digital image providing system according to claim 4, further comprising:
a second database which manages a decryption key for decrypting the encrypted information indicating the storage in association with customer information for identifying a customer;
wherein the encrypting device encrypts the information indicating the storage of the processing information with an encryption key different for each customer, and the decrypting device retrieves a corresponding decryption key based on the customer information from the second database and decrypts the encrypted information indicating the storage.

6. The digital image providing system according to claim 4, further comprising:
a device which retrieves the processing information from the first database based on information indicating the storage decrypted by the decrypting device;
an image processing device which processes the original image of the customer based on the retrieved processing information; and
an outputting device which outputs the original image subjected to the image-processing.

7. The digital image providing system according to claim 1, wherein the image processing performed on the original image comprises at least one of color correction, trimming and layout combine on the original image.

8. The digital image providing system according to claim 4, wherein the image processing performed on the original image comprises at least one of color correction, trimming and layout combine on the original image.

9. The digital image providing system according to claim 1, wherein the encrypted information is embedded in the original image as a digital watermark.

10. The digital image providing system according to claim 4, wherein the encrypted information is embedded in the original image as a digital watermark.

11. The digital image providing system according to claim 1, wherein the encrypted information is stored on the header of the image file where the original image is stored.

12. The digital image providing system according to claim 4, wherein the encrypted information is stored on the header of the image file where the original image is stored.
